(19) United States
(12) Patent Application Publication
(10) Pub. No.: US 2014/0245594 A1
(43) Pub. Date: Sep. 4, 2014

(54) METHOD & APPARATUS FOR GRIPPING

(71) Applicant: BALLTEC LIMITED, Lancashire (GB)

(72) Inventor: Owen Walmsley, Inverness-shire (GB)

(73) Assignee: BALLTEC LIMITED, Lancashire (GB)

(21) Appl. No.: 14/349,362

(22) PCT Filed: Oct. 4, 2012
(86) PCT No.: PCT/GB2012/052460

§ 371 Date: Apr. 3, 2014

(30) Foreign Application Priority Data
Oct. 4, 2011 (GB) 1117049.5

(51) Int. Cl. B25B 1/24

(52) U.S. Cl. CPC B25B 1/241
USPC 29/559; 269/156

(57) ABSTRACT

A method and apparatus for gripping elongate pieces, such as pipes, bars, beams, etc., are disclosed. The apparatus comprises a body, the body having an inner cavity for receiving a piece to be gripped, the inner cavity having a sidewall, a recess provided around at least a portion of the sidewall, a clamping member disposed within the recess, wherein the recess is adjustable from a first dimension, where the clamping member is located substantially within the recess, to a second dimension where the clamping member is urged out of the recess and into the inner cavity. The gripping method comprises the steps of locating a clamping member around a piece to be gripped, locating two clamping shoulders such that they flank the clamping member, compressing the clamping member by urging the clamping shoulders together, the clamping member being arranged such that axial compression of it translates to radial compression.

### FIELD OF THE INVENTION

The present invention relates to a method and apparatus for gripping, especially a method and apparatus for gripping elongate pieces, such as pipes, bars, beams, etc.

### BACKGROUND OF THE INVENTION

Elongate pieces such as pipes, bars and beams have to be manipulated and manoeuvred into place in a structure, such as a pipeline or a frame.

Such pieces may have considerable mass and dimensions, and therefore be cumbersome to properly and safely grip and transport to such a structure.

Prior art solutions have included simply using wire, rope, chain or other tether to surround the circumference of the piece to enable it to be lifted. This is not greatly secure. Increased security may be gained by machining an indentation around the circumference of the piece to provide a seat for the tether. However, this is disadvantageous in that the machining process requires time by a skilled operator, and also permanently alters the outer circumference of the piece providing it with a weakness both from the reduction in circumference and an area of potential stress concentration.

Specific gripping tools have been proposed. One such tool is disclosed in WO 0229301. It covers a fluid pressure actuated gripping device, and includes multiple parts, resulting in a complex device with associated manufacturing impediments.

### SUMMARY OF THE INVENTION

According to the present invention there is provided a gripping apparatus comprising a body, the body having an inner cavity for receiving a piece to be gripped, the inner cavity having a sidewall, a recess provided around at least a portion of the sidewall, a clamping member disposed within the recess, wherein the recess is adjustable from a first dimension, where the clamping member is located substantially within the recess, to a second dimension where the clamping member is urged out of the recess and into the inner cavity.

The piece to be gripped may be an elongate structure and may have a generally circular cross-section. Examples include pipes, tubes, bars and so forth.

The inner cavity may be substantially cylindrical. The recess may be also substantially cylindrical. The recess may alternatively be a toroidal from, such as a triangular toroid.

The recess may be provided around the full extent of the sidewall. The recess may be provided in a plane perpendicular to a main axis of the inner cavity.

The clamping member may include a clamping ring. The clamping ring may be split to enable compression from a first diameter to a second diameter, the first and second diameters corresponding with the first and second dimensions.

The clamping ring may have a generally circular cross-section. The clamping member or ring may also have other cross-sections, including a triangular cross-section.

The clamping ring may be disposed beside a shoulder within the recess. The clamping ring may be flanked on both sides by first and second shoulders.

The shoulders may comprise shoulder rings disposed within the recess. The shoulder rings may have generally circular cross-sections.

The shoulder rings may have a greater overall diameter than the clamping ring. The shoulder rings may have a lesser cross-sectional diameter than the clamping ring, or may indeed have an equal or greater cross-sectional diameter than the clamping ring.

The body may comprise a first body section and a second body section. The first and second body sections may be selectively movable with respect to one another. The first and second body sections may be co-operable to form the recess.

The first body section may be generally cylindrical. It may have a projecting spigot from an end about which the second body section is mounted.

The second body section may be generally cylindrical. It may have an increased diameter section in its inner sidewall in which the projecting spigot of the first body section is seated.

The increased diameter section may be located adjacent a lesser diameter section which forms an abutment. The projecting spigot, increased diameter section and/or abutment may cooperate to form the recess.

Alternatively, the first and second body sections may be generally polygonal toroids.

The first and second body sections may be mounted together on one or more elongate guide members. The guide members may be mounted through the first and second body sections via guide bores.

The one or more elongate guide members may be threaded, and threaded fasteners may be located on the outermost ends of the threaded elongate guide members to enable selective relative movement of the first and second body sections. The threaded fasteners may be nuts.

According to the present invention there is provided a gripping method comprising the steps of locating a clamping member around a piece to be gripped, locating two clamping shoulders such that they flank the clamping member, compressing the clamping member by urging the clamping shoulders together, the clamping member being arranged such that axial compression of it translates to radial compression.

The clamping member may include a clamping ring. The clamping ring may be split to enable compression from a first diameter to a second diameter, the first and second diameters corresponding with the first and second dimensions.

The clamping shoulders may be provided by shoulder rings. The shoulder rings may have a greater diameter than the clamping ring.

### BRIEF DESCRIPTION OF THE DRAWINGS

Embodiments of the invention will now be described, by way of example only, with reference to the following drawings, in which:

FIG. 1 is a sectional elevation of a gripping apparatus according to a first embodiment of the present invention in a first or expanded arrangement;

FIG. 2 is an end elevation of a clamping ring of the gripping apparatus of FIG. 1;

FIG. 3 is a sectional elevation of the gripping apparatus of FIG. 1 in a second or clamped arrangement;

FIG. 4 is a sectional elevation of a gripping apparatus according to a second embodiment of the present invention in a first or expanded arrangement;

FIG. 5 is a sectional elevation of the gripping apparatus of FIG. 4 in a second or clamped arrangement;

FIG. 6 is a sectional elevation of a gripping apparatus according to a third embodiment of the present invention in a second or clamped arrangement;

FIG. 7 is a sectional elevation of a gripping apparatus according to a fourth embodiment of the present invention in a second or clamped arrangement;

FIGS. 8 to 13 are progressive perspective views of the gripping apparatus of FIG. 7 being attached to a pipe PPPP;

FIG. 14 is an exploded perspective view of the gripping apparatus of FIG. 7;

FIG. 15 is an end elevation of a first body section of the gripping apparatus of FIG. 7;

FIG. 16 is a sectional plan view of the first body section of FIG. 15 on section D-D;

FIG. 17 is a plan view of the first body section of FIG. 15;

FIG. 18 is an end elevation of a second body section of the gripping apparatus of FIG. 7;

FIG. 19 is a sectional plan view of the second body section of FIG. 18 on section E-E;

FIG. 20 is a sectional plan view of the second body section of FIG. 18 on section G-G;

FIG. 21 is a further sectional plan view of the second body section of FIG. 18 on section H-H;

FIG. 22 is an end elevation of an end cap for use with the gripping apparatus of FIG. 7;

FIG. 23 is a plan view of end cap of FIG. 22;

FIG. 24 is a sectional plan view of the end cap of FIG. 22 on section A-A;

FIG. 25 is an end elevation of a clamping member of the gripping apparatus of FIG. 7;

FIG. 26 is a side elevation of the clamping member of FIG. 25;

FIG. 27 is an end elevation of a toroidal seal for use with the gripping apparatus of FIG. 7 and the end cap of FIG. 22; and

FIG. 28 is a plan sectional elevation of the toriodal seal of FIG. 27 on section B-B;

FIG. 29 is an end elevation of an alternative first body section compatible with the gripping apparatus of FIG. 7;

FIG. 30 is a sectional plan view of the alternative first body section of FIG. 29 on section D-D; and

FIG. 31 is side elevation of the first body section of FIG. 29.

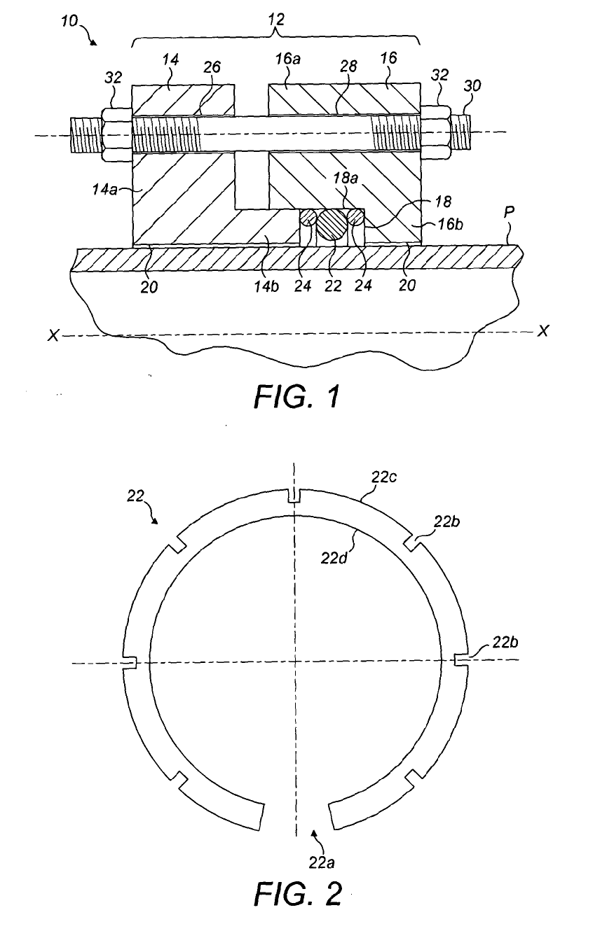

A gripping apparatus 10 is depicted in FIG. 1. It will be understood that this is a partial view: the apparatus 10 is substantially symmetrical and the lower sectional view (not shown) would be substantially identical to that depicted in FIG. 1, albeit inversed.

Apparatus 10 comprises a body 12. The body 12 further comprises a first body section 14 and a second body section 16.

The body 12 is generally cylindrical, as the present embodiment is intended to be used in gripping cylindrical pipe P. The gripping apparatus is largely symmetrical about axis X-X, which in FIG. 1 is also the major axis of the pipe P.

The interior of the body 12 has a cylindrical inner sidewall 18 and a cylindrical exterior sidewall 20.

The first body section 14 is essentially an L-shaped toroid, comprising a rectangular toroidal main section 14a extending from which is a spigot 14b.

The second body section 16 surrounds the spigot 14b and is also a generally L-shaped toroid. It comprises a rectangular toroidal main section 16a, which directly surrounds the spigot 14b.

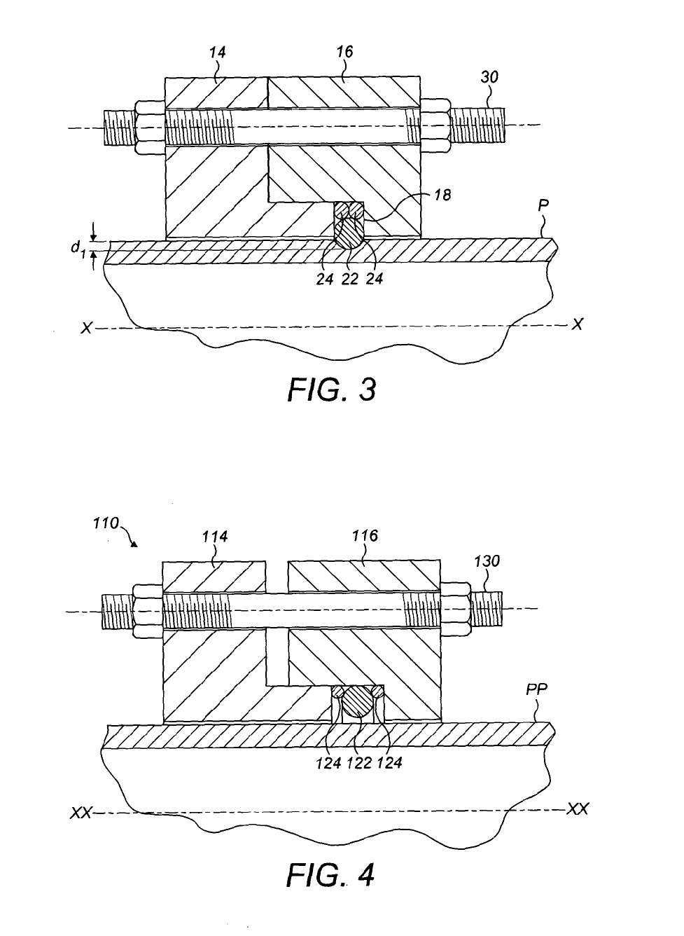

An increased diameter section 16b is provided adjacent the rectangular toroidal main section 16a. As will be seen from FIG. 1 and FIG. 3, the first 14 and second body sections 16 are complementary, such that when they are urged together, as will be subsequently described, they also form a substantially contiguous rectangular toroid.

The various dimensions of the first 14 and second body sections 16 are also complementary, such that there is a sliding fit of the two sections. The axial dimension of the spigot 14b is slightly less than the axial dimension of the rectangular toroidal main section 16a, such that a recess 18 is formed in the inner sidewall 20.

The recess 18 extends generally as a rectangular toroid extending axially out from axis X-X. A clamping member 22 is housed within the recess 18. The clamping member 22 is a generally ring-shaped member. FIG. 2 depicts an end elevation of the clamping member 22. It is a discontinuous ring, having a gap 22a around its circumference. Further, ring indentations 22b are provided around its exterior circumference 22c. The clamping member 22 has a generally circular cross-section, as can be seen from FIG. 1. The clamping member 22 is formed from hardened steel. The skilled addressee will be aware of suitable steels for the purpose, or be aware that other materials may be appropriate and suitable.

The clamping member 22 is seated within the recess 18, and given its resilience would tend to urge against the outer wall 18a of the recess 18.

Two shoulders 24 are also seated within the recess 18, disposed either side of the clamping member 22. They are of a similar arrangement to the clamping member 22 being discontinuous ring members, albeit they have a smaller cross-sectional diameter. They also urge against the outer wall 18a of the recess 18. It is advantageous if the cross-sectional diameter of the shoulders 24 is less than 50% of the cross-sectional diameter of the clamping member 22. That way, the contact between the shoulders 24 and the clamping member 22 is towards the outer circumference 22c of the clamping member 22 and the inner circumference of the shoulders 24.

Two bores 26,28 are provided through respectively through first 14 and second body sections 16. The bores 26,28 are parallel to the axis X-X and coaxial with one another.

A threaded guide member 30 is located within both bores 26,28 and provide a further attachment means for the first 14 and second body sections 16. Two threaded fasteners, simple nuts 32, are located at the opposite ends of the guide member 30 with the first 14 and second body sections 16 located between them. It will be understood that around the circumference of the apparatus 10 there will be further guide members and nuts disposed. In the present embodiment there will be a total of eight guide member and nut arrangements around the circumference of the apparatus 10. It will be understood to the skilled addressee that the number of such arrangements may be varied.

In use, the apparatus 10 is fed over a pipe P in an “open” position as defined in FIG. 1 i.e. the first 14 and second body sections 16 are spaced slightly apart and the recess 18 has a first axial dimension. In this arrangement, the shoulders 24 and the clamping member 22 are not axially restricted by interference with each other, and their inherent resilience enables them to urge against the outer wall 18a of the recess 18. The inner circumference 22d of the clamping member 22 is also within the recess 18 and does not contact the pipe P.

The nuts 32 are then tightened which forces the first 14 and second body sections 16 together. This causes the axial dimension of the recess 18 to reduce eventually reaching a second dimension as shown in FIG. 3.

Whilst the axial dimension is being reduced, the shoulders 24 are urged together. Since the contact points between the shoulders 24 and the clamping member 22 are towards the outer circumference 22a of the clamping member, the urging of the shoulders 24 together causes the diameter of the clamping member 22 to be restricted and forces its inner circumference 22d towards the pipe P, thereby reducing the overall diameter i.e. the diameter of the ring itself rather than its cross-sectional diameter. The gap 22a and the ring indentations 22b assist in the diameter restriction mechanism, reducing the force required to do so, and preventing any unwanted axial deformation mechanism as may be the case with a continuous ring.

Eventually the inner circumference 22d contacts the outer surface of pipe P. As shown in FIG. 3, it is advantageous if the inner circumference 22d is reduced to a diameter less than that of the outer diameter of the pipe P. A pinched waist forms in the pipe P to a depth of d₁ . This may be a purely elastic deformation of the pipe P or may include a plastic deformation.

Formation of the pinched waist aids gripping of the pipe P in at least two ways: first, there will be a substantially radial reaction force against the clamping member 22 and the pinched waist will also mitigate relative axial movement of apparatus 10 with respect to pipe P.

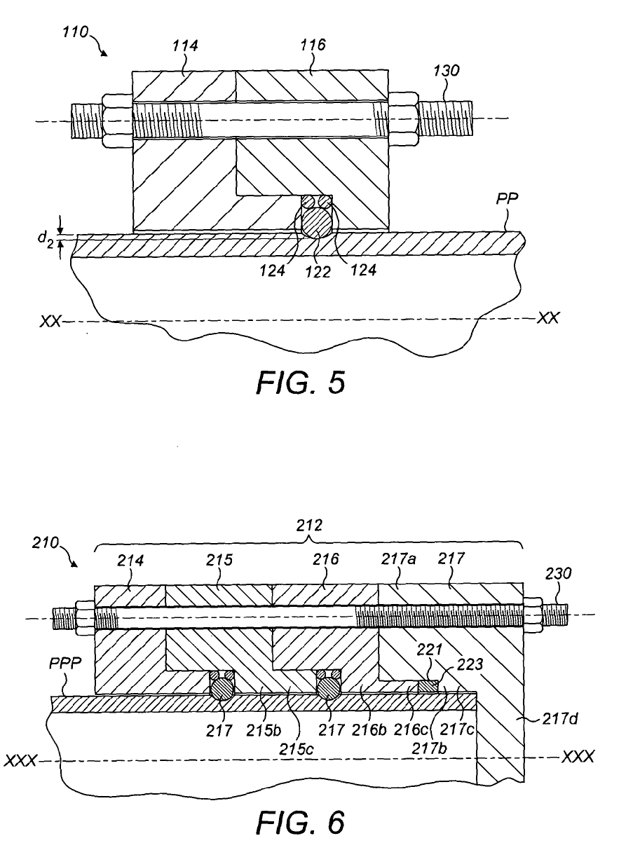

A second embodiment of the present invention is shown in FIGS. 4 and 5, in a corresponding “open” and “closed” position to that depicted in FIGS. 1 and 3 of the first embodiment. The second embodiment has similar features to that of the first embodiment, and a similar numbering scheme has been employed, except with addition of a prefixing “1”, or in the case of the lettered features X-X and P, these have been prefixed with the same letter, becoming XX-XX and PP. The depth by which the pinched waist is below the outer surface of the pipe PP is denoted by d₂.

The main difference is the relative sizing of the cross-sectional diameters of the clamping member 122 and shoulders 124. In this embodiment the shoulders 124 are of relatively lesser cross-sectional diameter with respect to the clamping member 122. This has virtually no difference to the functionality of the embodiment as described above, with the second embodiment functioning largely similar to the first embodiment.

One main difference is that it will be noted that when the larger shoulders 24 of the first embodiment are brought together, they come into direct contact with one another within the recess 18 (see FIG. 3).

In the second embodiment, the relatively smaller shoulders 124 do not come into direct contact with one another within the recess 118 (See FIG. 5). Furthermore, the radial inward movement of the clamping ring 122 is less and therefore d₂ would be less than d₁ for the same size of clamping ring.

A third embodiment of the present invention is shown in FIG. 6. The third embodiment has similar features to that of the first and second embodiments, and a similar numbering scheme has been employed, except with addition of a prefixing “2”, or in the case of the lettered features X-X and P, these have been prefixed with the same letter, becoming XXX-XXX and PPP.

The body 212 of the third embodiment comprises more individual sections than that of the first and second embodiments. The third embodiment body 212 comprises a first body section 214 largely similar in configuration to that of the first and second embodiments, with intermediate second 215 and third body sections 216, and an end cap 217. The second 215 and third body sections 216 are similar to the second body sections 16,116 of the first and second embodiments; however, they also include respective spigots 215c,216c projecting from the increased diameter section 215b,216b. The spigot 215c of the second body section 215 projects axially away from the first body section 214 and towards the third body sections 216. The third body section 216 mounts around that spigot 215c, and likewise the end cap 217 mounts around the spigot 216c of the third body section 216. The spigot 215c is, in this embodiment, thicker (i.e. is of greater diameter) than spigot 216c, but this is simply a design consideration and not essential for the function of the invention.

This forms two recesses 218 (between first body section 214 and second body section 215) and 219 (between second body section 215 and third body section 217). Functioning of the gripping members and shoulders within these sections is largely identical to that described above.

End cap 217 comprises a thin sleeve section 217a which surrounds spigot 216c, a transition chamfer section 217b leading to a thick sleeve section 217c which more closely surrounds pipe PPP, and an end plate 217d located opposite the second body section 216.

The junction of spigot 216c, thin sleeve section 217a, transition chamfer section 217b and thick sleeve section 217c creates a seal recess 221. An elastomeric seal 223 is located within this seal recess 221. This end cap 217 allows pipe PPP to be sealed thereby mitigating fluid ingress or egress.

It also provides two gripping points from the two separate clamping member/shoulder arrangements.

It will be understood that further clamping members may be added by the addition of further body sections, and the end cap may be omitted if desirable, without departing from the scope of the present invention.

Although described above as discontinuous ring members, the shoulders 24 may be continuous ring members i.e. complete tori.

Although advantageous, neither shoulders nor clamping members require a circular cross-section. They may have, for example, oval cross-sections, or the shoulders may have square cross-sections. The circular cross-sections enable a smooth and stable clamping mechanism, without incurring undesirable point-loading.

Furthermore, although described generally with the shoulder rings having lesser cross-sectional diameters than the clamping rings, they may be equal in cross-sectional, or indeed the cross sectional diameters of the shoulder rings may exceed that of the clamping ring.

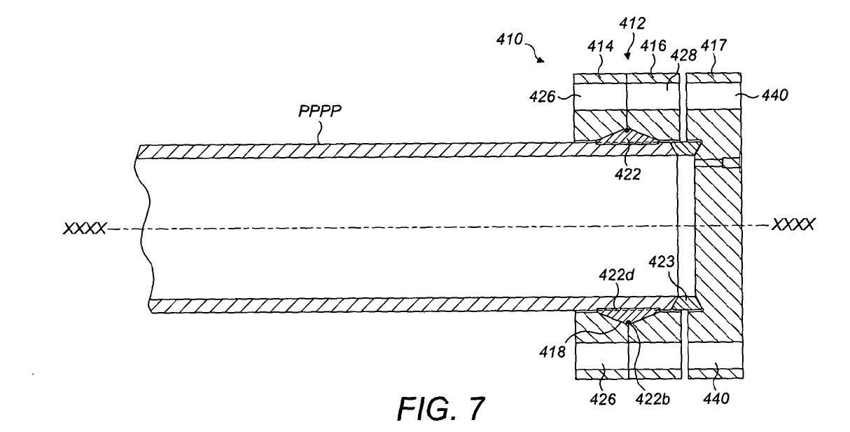

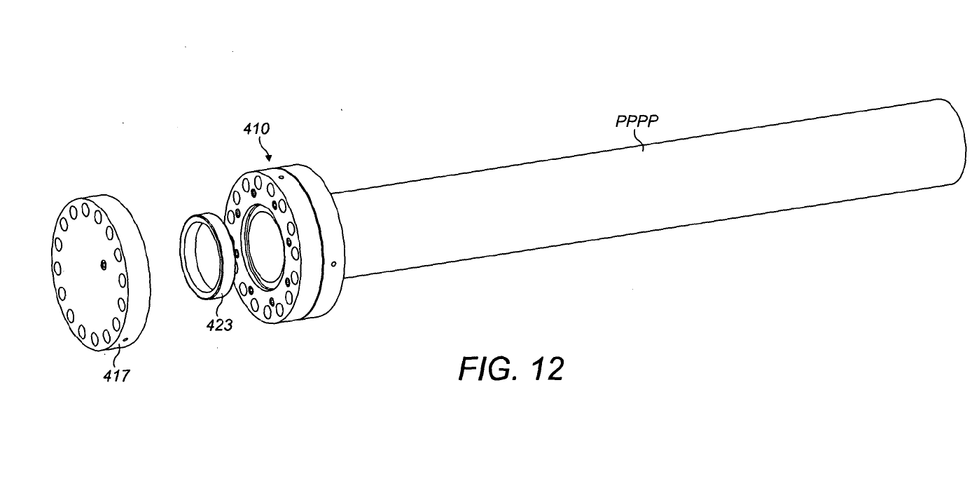

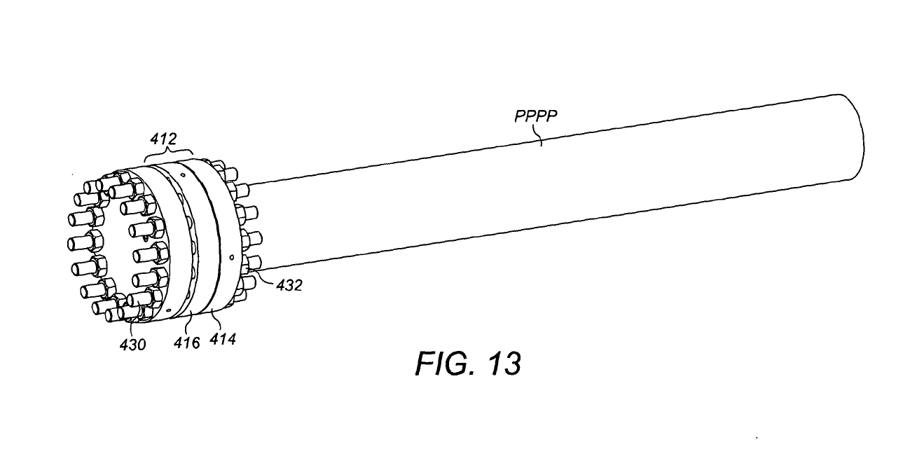

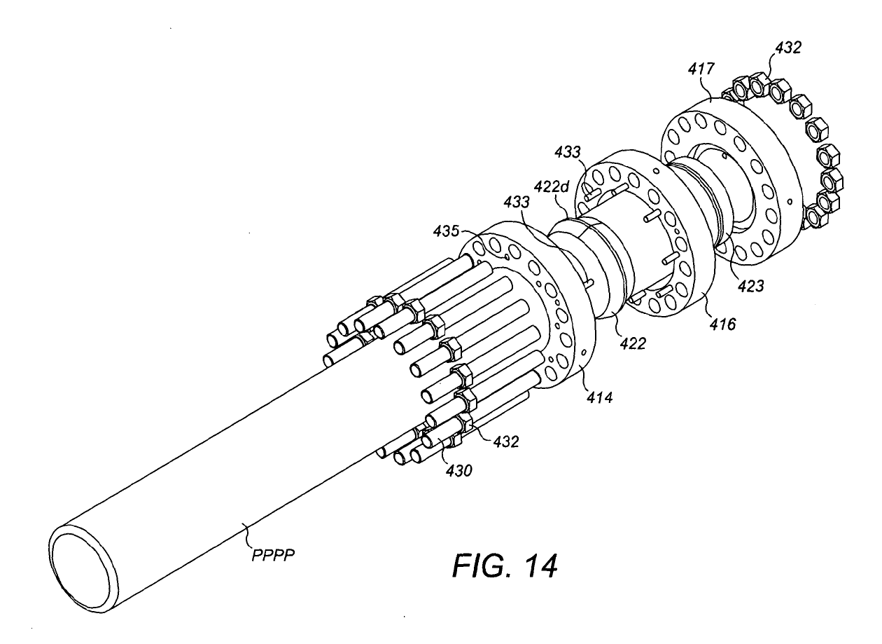

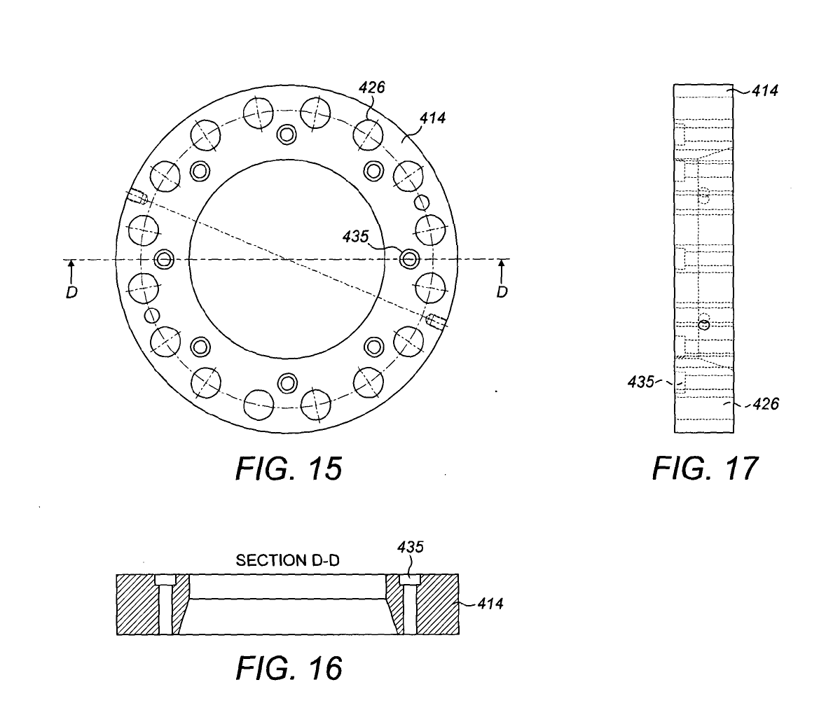

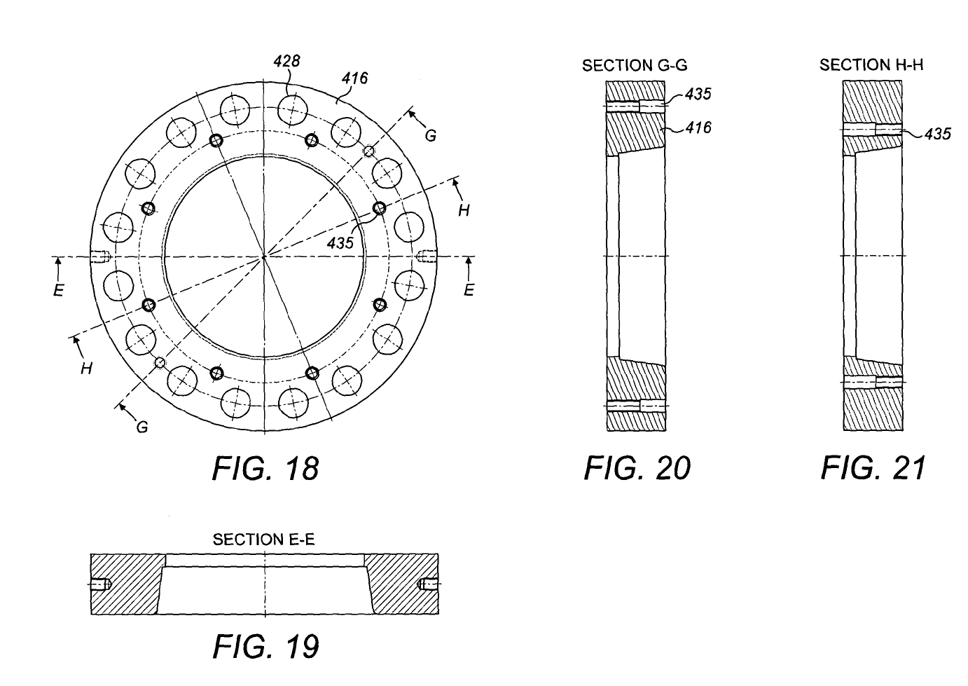

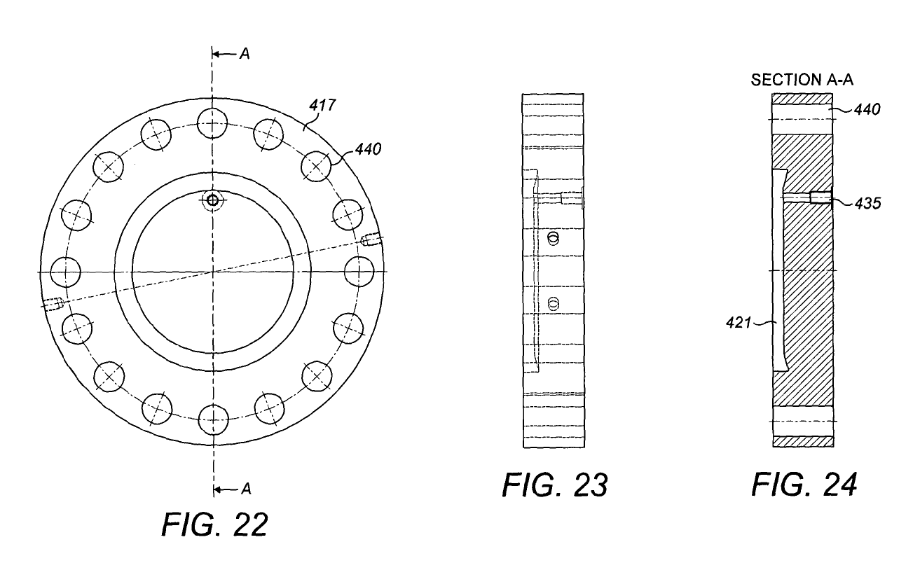

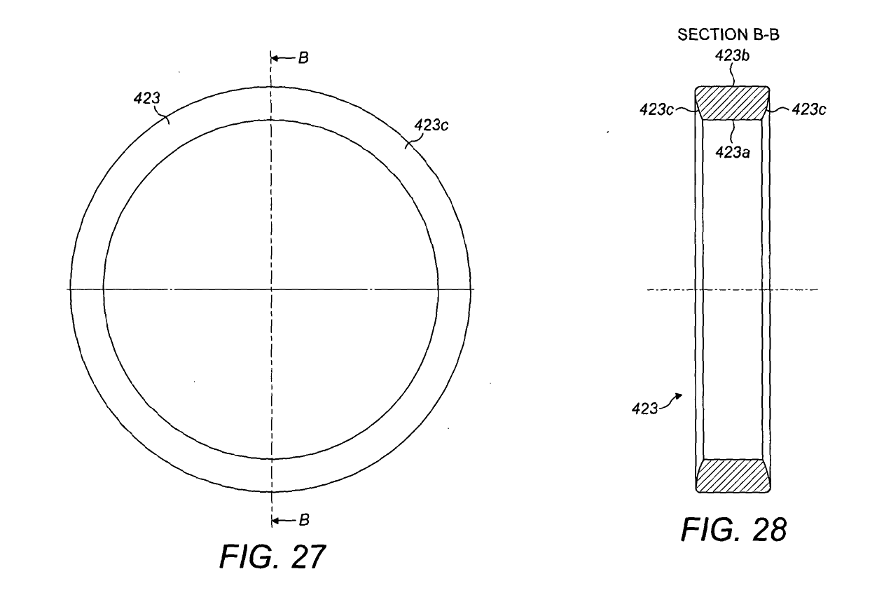

A fourth embodiment of the present invention is shown in FIG. 7 to FIG. 28. The fourth embodiment has similar features to that of the first, second third embodiments, and a similar numbering scheme has been employed, except with the addition of a prefixing “4”, or in the case of the lettered features X-X and P, these have been prefixed with the same letter, becoming XXXX-XXXX and PPPP.

The fourth embodiment is of a pipe gripping apparatus 410. Apparatus 410 comprises a body 412. The body 412 further comprises a first body section 414 and a second body section 416.

The body 412 is generally cylindrical, or as can be seen from FIG. 7, toroidal, as the present embodiment is intended to be used in gripping cylindrical pipe PPPP. The gripping apparatus 410 is largely symmetrical about axis XXXX-XXXX, which in FIG. 7 is also the major axis of the pipe PPPP.

Each body section 414, 416 is a substantially pentagonal toroid. When adjacent each other in the closed position as shown in FIG. 7 to form the body 412 the recess 418 which is thereby formed is a generally triangular toroid.

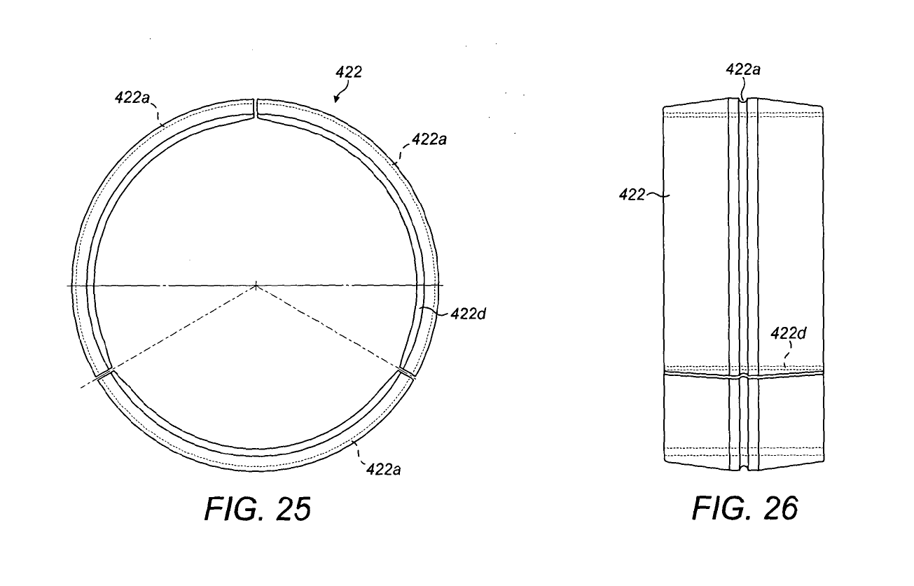

The clamping member 422 is a complementary generally triangular toroid. Further detail of the constructions of the clamping member 422 is shown in FIGS. 25 and 26. The clamping member 422 comprises three toroidal sections 422a, each forming approximately 120° of the toroidal clamping member 422. A ring recess 422b is provided around the outermost edge of the toroidal clamping member 422 in which a toroid elastomeric ring 422c is seated and connects the three toroidal sections 422a. It will be appreciated that it is optimal that the inner diameter of the toroidal clamping member 422, when each of the three toroidal sections 422a are in contact to form a contiguous member, will be equal to or slightly less than the outer diameter of the pipe PPPP. Thus, when the apparatus 410 is clamped around the pipe PPPP it will provide a secure grip.

Teeth 422d are provided on the inner surface of the toroidal clamping member 422. The teeth 422d are in the form of a threaded inner surface of the toroidal clamping member. They may also be in the form of circumferentially arranged or laterally arranged raised portions or any other arrangement which provides point loadings between the clamping member 422 and the pipe PPPP.

An end cap 417 is disposed beside the apparatus 410 adjacent the second body section 416. It functions much as end cap 217 described above. The end cap 417 is a substantially cylindrical disc which caps and closes off the pipe PPPP.

A toroidal seal 423 is provided between end cap 417 and pipe PPPP. A complementary toroidal seal recess 421 is provided on the inner face of the end cap 417. The toroidal seal 423 may be formed from the same material as either the pipe or the apparatus 410, usually a metal. The toroidal seal may even be machined from a spare section of pipe left over from the installation of the pipe PPPP.

The toroidal seal 423 has a generally isosceles trapezoidal cross-section; however, as can be seen more clearly in FIG. 28, the cross-section itself is slightly more specific than this general description. The innermost edge 423a (from the perspective of the toroid formed) of the cross-section is substantially linear as is the outermost edge 423b. Both innermost edge 423a and outermost edge 423b are substantially parallel to the axis XXXX-XXXX. The innermost edge 423a has a lesser lateral dimension that the outermost edge 423b.

Intermediate edges 423c, which are arranged between outermost edge 423b and innermost edge 423a, are not linear but curve outwardly in a convex manner. They form an outward bulge around either face of the toroidal seal 423. As can be seen from FIG. 7, the end of the pipe PPPP to which the apparatus 410 is attached is prepared to receive the toroidal seal 423 by being machined such that the leading edge has a complementary angled surface to meet the toroidal seal 423.

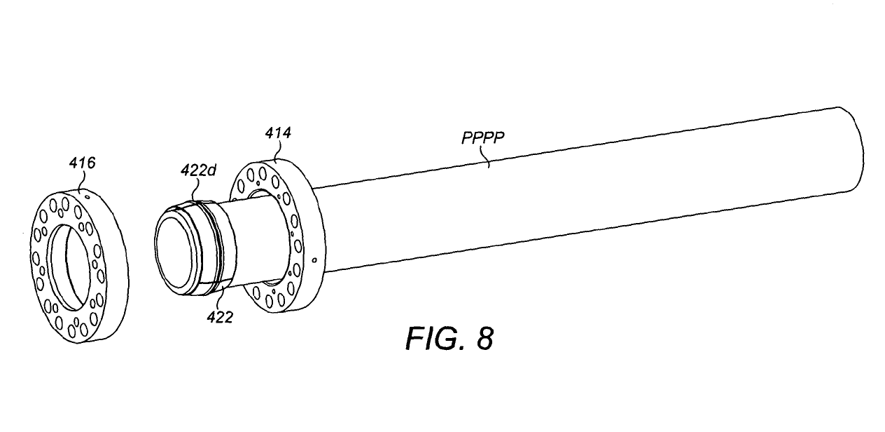

FIGS. 8 to 13 illustrate the method of attaching the apparatus 410 to the pipe PPPP. The pipe PPPP is first machined to have the angled leading edge. First body section 414 is placed over the pipe PPPP followed by the clamping member 422. The second body section is placed over the pipe PPPP next such that the clamping member is located between first body section 414 and second body section 416 (FIG. 8).

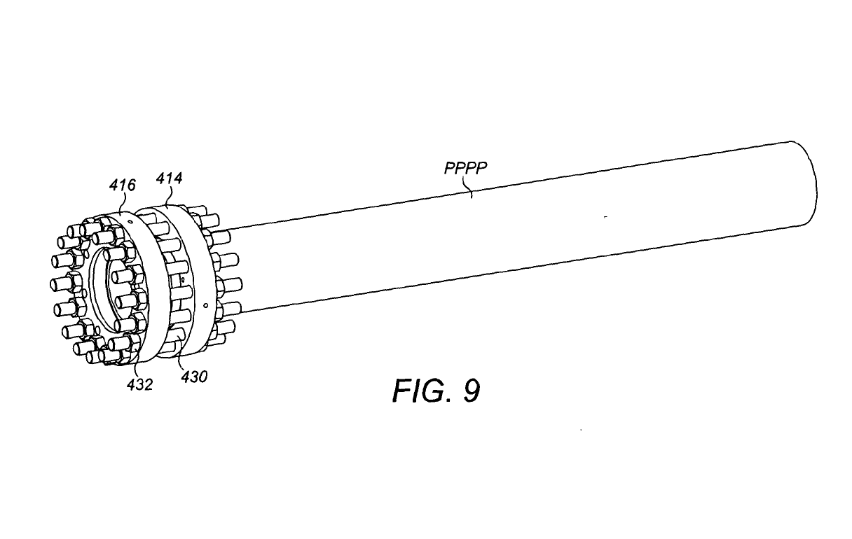

Placement bolts 430 are fed through placement bores 426,428 and corresponding nuts 432 are screwed onto the bolts 430, such that both body sections 414,416 are flanked by nuts 430 (FIG. 9).

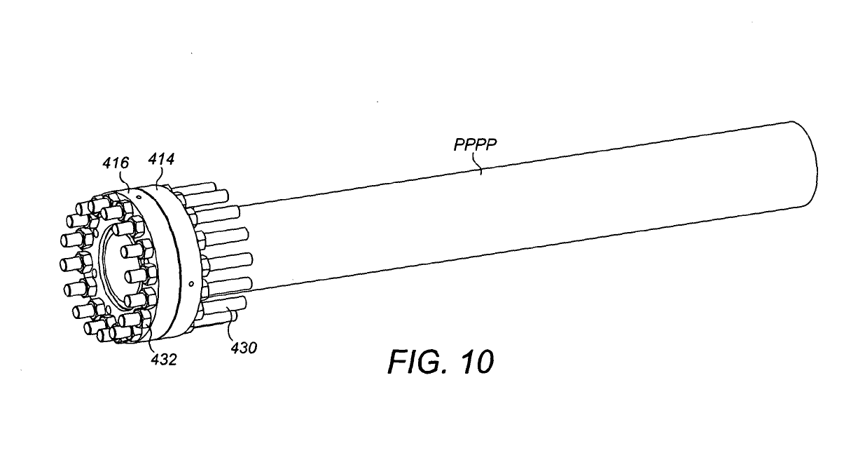

The nuts 432 are tightened drawing them together. This in turn urges the body sections 414, 416 together. As either side of the recess 418 comes together, it urges the clamping member 422 radially towards the pipe PPPP and reduces its diameter. The angled edges of the body sections that form the recess act as shoulders that urge the clamping member in this fashion. The teeth 422d contact the pipe PPPP and the point loading thereof will begin to plastically deform the outer surface of the pipe, ensuring a secure grip (FIG. 10).

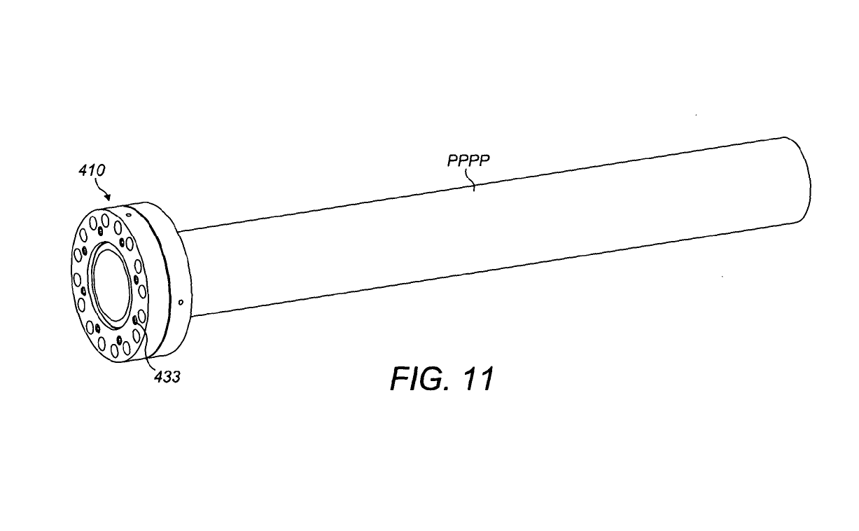

Once the body sections 414,416 are adjacent one another and touching to form the body section 412, securing bolts 433 are screwed into tapped securing bores 435, which hold the body sections 414,416 together. Placement bolts 430 and nuts 432 are then removed (FIG. 11). In this arrangement, the apparatus 410 may function as simple pipe gripping apparatus.

FIG. 12 details the placement of a toroidal seal 423 and end cap 417. The toroidal seal 423 is placed over the machined end of the pipe PPPP adjacent the second body section 416. The end cap 417 is placed over the toroidal seal 423 and the machined end of the pipe PPPP with the toroidal seal 423 being seated within toroidal seal recess 421.

Placement bolts 430 are again fed through placement bores 426,428,440 and corresponding nuts 432 are screwed onto the bolts 430, such that the first body section 414 and the end cap 417 are flanked by nuts 430. The nuts 432 are tightened drawing them together. This in turn urges the body sections 414, 416 and the end cap 417 together.

The toroidal seal 423 is compressed as the toroidal seal recess 421 is urged towards the pipe end PPPP. This compression causes a deformation of the toroidal seal recess 421. The machined end of the pipe will also tend to deform under this compression. The intermediate edges 423c tend to become less convex and more linear and correspondingly, the toriodal seal 423 expands slightly in diameter from its first or rest diameter to a second or sealing diameter. It will be appreciated that this expansion of en elastically deformable material such as a metal will result in a compressive force between the pipe end PPPP and the toroidal seal 423c. There will be a point-like loading between the intermediate edges 423c, the machined pipe end and the seal recess 421. An axial seal is therefore created between the machined pipe end and the intermediate pipe edge 423c. Elastic deformation of the materials that make up the various components should provide a positive bias for this sealing point.

Once the body section 412 and end cap 417 are adjacent one another and touching, securing bolts 433 are screwed into tapped securing bores 435, which holds the end cap 417 to the body 412. Placement bolts 430 and nuts 432 are then removed. In this arrangement, the pipe PPPP is sealed at its end.

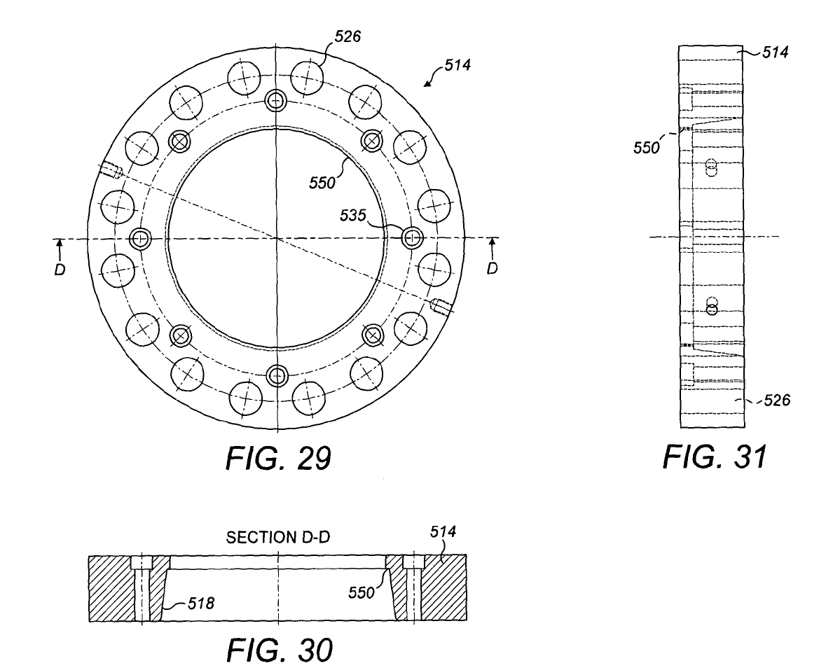

FIGS. 29 to 31 depict an alternative first body section 514 usable as replacement for the first body section 414 described above. It is similar to the first body section described above with similar or identical features prefixed “5” instead of “4”. The main difference is that a lip 550 has been formed into the first body section 514 between the recess portion 518 and the remainder of the inner cavity. This lip 550 provides an abutment against which the clamping member 422 will be restrained from moving out of the recess 518 to a greater extent than desired. A complementary lip may be provided in a similarly constructed alternative second body section (not shown) providing a similar function.

Further modifications and improvements may be made without departing from the scope of the present invention. For example, although described as being constructed from three sections, the clamping member may comprise one continuous member, a discontinuous member as per the first embodiment, two sections, four sections, or as many as may be deemed appropriate by the skilled addressee. Furthermore, although described as gripping apparatus, it will be understood by the skilled addressee that the present invention may be used as a pipe connector or in other suitable applications.

1. Gripping apparatus comprising a body, the body having an inner cavity for receiving a piece to be gripped, the inner cavity having a sidewall, a recess provided around at least a portion of the sidewall, a clamping member disposed within the recess, wherein the recess is adjustable from a first dimension, where the clamping member is located substantially within the recess, to a second dimension where the clamping member is urged out of the recess and into the inner cavity.

2. Gripping apparatus according to claim 1 wherein the inner cavity is substantially cylindrical.

3. Gripping apparatus according to claim 1 wherein the recess is substantially cylindrical.

4. Gripping apparatus according to claim 1 wherein the recess is a substantially toroidal.

5. Gripping apparatus according to claim 4 wherein the toroidal recess has a triangular cross-section.

6. Gripping apparatus according to claim 1 wherein the recess is provided around the full extent of the sidewall.

7. Gripping apparatus according to claim 1 wherein the clamping member includes a clamping ring.

8. Gripping apparatus according to claim 7 wherein the clamping ring is split to enable compression from a first diameter to a second diameter, the first and second diameters corresponding with the first and second dimensions.

9. Gripping apparatus according to claim 7 wherein the clamping ring has a generally circular cross-section.

10. Gripping apparatus according to claim 7 wherein the clamping ring has a generally triangular cross-section.

11. Gripping apparatus according claim 7 wherein the clamping ring is disposed beside a shoulder within the recess.

12. Gripping apparatus according to claim 7 wherein the clamping ring is flanked on both sides by first and second shoulders.

13. Gripping apparatus according to claim 7 wherein the shoulder(s) comprise shoulder ring(s) disposed within the recess.

14. Gripping apparatus according to claim 13 wherein the shoulder rings have generally circular cross-sections.

15. Gripping apparatus according to claim 13 wherein the shoulder rings have a greater overall diameter than the clamping ring.

16. Gripping apparatus according to claim 13 wherein the body comprises a first body section and a second body section.

17. Gripping apparatus according to claim 16 wherein the first and second body sections are selectively movable with respect to one another.

18. Gripping apparatus according to claim 16 wherein the first and second body sections co-operate to form the recess.

19. Gripping apparatus according to claim 16 wherein the first body section is generally cylindrical.

20. Gripping apparatus according to claim 16 wherein the first body section has a projecting spigot from an end about which the second body section is mounted.

21. Gripping apparatus according to claim 16 wherein the second body section is generally cylindrical.

22. Gripping apparatus according to claim 21 wherein the second body section has an increased diameter section in its inner sidewall in which the projecting spigot of the first body section is seated.

23. Gripping apparatus according to claim 22 wherein the increased diameter section is located adjacent a lesser diameter section which forms an abutment.

24. Gripping apparatus according to claim 16 wherein the first and second body sections are mounted together on one or more elongate guide members.

25. Gripping apparatus according to claim 16 wherein the one or more elongate guide members are threaded, and threaded fasteners are located on the outermost ends of the threaded elongate guide members to enable selective relative movement of the first and second body sections.

26. A gripping method comprising the steps of locating a clamping member around a piece to be gripped, locating two clamping shoulders such that they flank the clamping member, compressing the clamping member by urging the clamping shoulders together, the clamping member being arranged such that axial compression of it translates to radial compression.

27. A gripping method according to claim 26 wherein the clamping member includes a clamping ring.

28. A gripping method according to claim 27 wherein the clamping ring is split to enable compression from a first diameter to a second diameter.

29. A gripping method according to claim 26 wherein the clamping shoulders may be provided by shoulder rings.

30. A gripping method according to claim 26 wherein the shoulder rings have a greater overall diameter than the clamping ring.
